(19) United States
(12) Patent Application Publication
(10) Pub. No.: US 2009/0125504 A1
(43) Pub. Date: May 14, 2009

(54) Systems and methods for visualizing web page query results

(76) Inventors: Randy Adams, Menlo Park, CA (US); Mark D. Kvamme, Atherton, CA (US)

Correspondence Address: JONES DAY, 222 EAST 41ST ST, NEW YORK, NY, 10017, US

(21) Appl. No.: 11/983,629

(22) Filed: Nov. 8, 2007

(51) Int. Cl. G06F 17/30

(52) U.S. Cl. 707/5; 707/E17.108

(57) ABSTRACT

Systems and methods for providing search results responsive to a search query are provided. A submitted search query is received from a search requester. Search results relevant to the search query are obtained from a document index. Each search result comprises (i) a source document or a reference to a source document and (ii) a static graphic representation of the source document. The static graphic representation of the source document was obtained from the source document at a time before the submitted search query was received. The static graphic representation of the source document of a first search result in the search results is displayed in a center position of a graphic output device. The static graphic representation of the source document of a second search result in the search results is displayed in an off-center position of the graphic output device. The static graphic representation of the source document of the second search result is displayed rotated about an axis of rotation that lies between the center position and the off-center position.

### 1. FIELD OF THE INVENTION

The present application relates generally to information search and retrieval. More specifically, systems and methods are disclosed for improving how search results from vertical collections or other forms of document indexes are viewed by a search requester.

### 2. BACKGROUND

Search engines typically provide a source of indexed documents from the Internet (or an intranet) that can be rapidly scanned in response to a search query submitted by a search requester. As the number of documents accessible via the Internet grows, the number of documents that match a particular query (“hits”) may also increase. Sifting through all of the hits poses a challenge to a search requester. Conventional search engines provide a small excerpt from each hit, and the excerpts are ordered based on their relevance to the search requesters' query. One way to order documents is the PageRank algorithm more fully described in the article “The Anatomy of a Large-Scale Hypertextual Search Engine” by S. Brin and L. Page, 7^{th} International World Wide Web Conference, Brisbane, Australia and U.S. Pat. No. 6,285,999. However, even when ranked by relevance, the display of small excerpts for each of the hits requires careful study of the hits by the search requester. Some search engines, such as ask.com, provide a graphic illustration of the source documents that correspond to the hits of a search query. However, improvement is needed on how such graphic illustrations are presented to the user. For instance, using ask.com, a user must ascertain using simple text describing a hit whether the hit should be “opened” to the graphic illustration form of the hit. While functional, such a process is unsatisfactory.

Given the above background, what is needed in the art are improved systems and methods for displaying the hits from searches of document repositories that have been submitted by a search requester.

### 3. SUMMARY

The present application addresses the deficiencies present in the known art. For each search query hit responsive to a search query, a (i) source document or a reference to a source document and (ii) a static graphic representation of the source document is retrieved. In preferred embodiments, the static graphic representation of the source document is obtained from the source document at a time before the submitted search query was received. In some embodiments, the static graphic representation of the source document is obtained from the source document after the search query has been received and after the source document is identified as a “hit” to the search query. Advantageously, rather than displaying a simple text message for each search query hit, the static graphic representations of source documents are displayed. For instance, in one embodiment illustrated in FIG. 8, the static graphic representation of the source documents of a first search result is displayed in a second off-center position, thereby causing the static graphic representation of the source document of the first search result to be displayed at the second off-center position rotated about a second axis of rotation that lies between a center position and the second off-center position, (ii) the static graphic representation of the source document of a second search result is displayed at the center position, and (iii) the static graphic representation of the source document of a third search result is displayed in a first off-center position, where the static graphic representation of the source document of the third search result is displayed rotated (e.g., at least one degree out of the plane of the graphic output device, at least two degrees out of the plane of the graphic output device, at least three degrees out of plane of the graphic output device, at least five degrees out of plane of the graphic output device) about a first axis of rotation that lies between the center position and the first off-center position.

One aspect of the present disclosure provides a method for providing search results responsive to a search query in which a submitted search query is received from a search requester. A first plurality of search results relevant to the submitted search query is obtained from a document index. Each search result in the first plurality of search results comprises (i) a source document or a reference to a source document and (ii) a static graphic representation of the source document, where the static graphic representation of the source document was obtained from the source document at a time before the submitted search query was received. The static graphic representation of the source document of a first search result is displayed in a center position of a graphic output device. The static graphic representation of the source document of a second search result is displayed in a first off-center position of the graphic output device. The static graphic representation of the source document of the second search result is displayed rotated about a first axis of rotation that lies between the center position and the first off-center position of the graphic output device.

In some embodiments, the method further comprises, responsive to a selection of the static graphic representation of the source document of the second search result in the first off-center position, the steps of: (i) shifting the static graphic representation of the source document of the first search result to a second off-center position of the graphic output device, thereby causing the static graphic representation of the source document of the first search result to be displayed at the second off-center position rotated (e.g., at least one degree out of the plane of the graphic output device, at least two degrees out of the plane of the graphic output device, at least three degrees out of plane of the graphic output device, at least five degrees out of plane of the graphic output device) about a second axis of rotation that lies between the center position and the second off-center position of the graphic output device, (ii) shifting the static graphic representation of the source document of the second search result to the center position of the graphic output device, thereby causing the static graphic representation of the source document of the second search result to be displayed at the center position in a manner that is no longer rotated about the first axis of rotation, and (iii) displaying the static graphic representation of the source document of a third search result in the first plurality of search results in the first off-center position of the graphic output device, where the static graphic representation of the source document of the third search result is displayed rotated about the first axis of rotation.

In some embodiments, the method further comprises, responsive to a selection of the static graphic representation of the source document of the first search result in the first plurality of search results in the second off-center position, the steps of: (i) shifting the static graphic representation of the source document of the first search result to the center position, thereby causing the static graphic representation of the source document of the first search result to be displayed at the center position in a manner that is no longer rotated about the second axis of rotation, and (ii) shifting the static graphic representation of the source document of the second search result to the first off-center position, thereby causing the static graphic representation of the source document of the second search result to be displayed at the first off-center position in a manner that is rotated about the first axis of rotation.

In some embodiments, the method further comprises removing the static graphic representation of the source document of the third search result in the first off-center position. In some embodiments, the method further comprises, responsive to a selection of the static representation of the source document of the first search result in the center position, the step of enlarging a size of the static graphic representation of the source document of the first search result. In some embodiments, the method further comprises, responsive to a selection of a portion of the graphic output device outside of the static representation of the source document of the first search result when the static representation is in its enlarged state, the step of reducing the size of the static graphic representation to an original size.

In some embodiments, the method further comprises, responsive to a selection of the static representation of the source document of the first search result, the steps of (i) retrieving a web page impression from the source document and (ii) replacing the static graphic representation of the source document with the web page impression. In some embodiments, the method further comprises, responsive to a selection of the static representation of the source document of the first search result in the center position, the step of flipping the static graphic representation of the source document from a first side to a reverse side so that the reverse side of the static graphic representation is shown (displayed). The reverse side of the static graphic representation contains, in some embodiments, information associated with the static graphic representation.

In some embodiments, the method further comprises providing a toggle bar on the graphic output device so that (i) when the search requester pulls the toggle bar in a first direction, the static graphic representations of search results in the first plurality of search results shift from the first off-center position to the center position, and from the center position to a second off-center position responsive to the pull in the first direction; and (ii) when the search requester pulls the toggle bar in a second direction, the static graphic representations of search results in the first plurality of search results shift from the second off-center position to the center position, and from the center position to the first off-center position responsive to the pull in the second direction.

In some embodiments, the method further comprises embedding an advertisement into the first plurality of search results as a static graphic representation, where, when the search requester pulls the toggle bar in the first direction or the second direction, an advertisement is displayed in the center position. In some embodiments, the method further comprises responsive to a selection and drag on the static graphic representation of the source document of the first search result in the direction of a predetermined position on the graphic output device, storing a copy of the static graphic representation of the source document of the first search result on a client device.

In some embodiments, the method further comprises embedding an advertisement into the first plurality of search results as a static graphic representation. In some embodiments, the method further comprises automatically transforming, without user input, the static graphic representation of the source document of the first search result to a live impression from the source document.

In some embodiments, each search result in the first plurality of search results belongs to one or more categories and the method further comprises receiving instructions from the search requester to remove a search result from the first plurality of search results and, responsive to the instructions to remove the search result, (i) modifying the search query to account for the removal of the search result from the first plurality of search results, thereby forming a modified search query, (ii) submitting the modified search query to a search engine in a remote computer; and (iii) obtaining a second plurality of search results relevant to the modified search query.

In some embodiments, the static graphic representation of the source document is a graphic representation of an entire web page that is at the source document at the time before the submitted search query was received.

Another aspect of the present disclosure provides a method for providing search results responsive to a search query, in which a submitted search query is received from a search requester using a client device. A search of a document index is performed using the submitted search query thereby identifying a plurality of search results relevant to the submitted search query from the document index. Each search result (“hit”) in the first plurality of search results comprises (i) a source document or a reference to a source document and (ii) a static graphic representation of the source document, where the static graphic representation is a graphic representation of an entire web page at the source document that was obtained from the source document at a time before the submitted search query was received. The plurality of search results is then reported to the client device.

Still another aspect of the present disclosure provides a method for modifying a set of search results. The method comprises receiving a search request from a search requester. A first plurality of search results relevant to the submitted search query is then obtained from a document index, where each search result in the first plurality of search results comprises: (i) a source document or a reference to a source document and (ii) a static graphic representation of the source document, where the static graphic representation of the source document was obtained from the source document at a time before the submitted search query was received. Furthermore, each search result in the first plurality of search results belongs to one or more categories. Instructions are received from the search requester to remove a search result from the first plurality of search results and, responsive to the instructions to remove the search result, (i) the search query is modified to account for the removal of the search result from the first plurality of search results, thereby forming a modified search query, (ii) a modified search of a document index is performed using the modified search query and (iii) a second plurality of search results relevant to the modified search query is obtained.

Another aspect of the present disclosure provides a computer program product for use in conjunction with a computer system. The computer program product comprises a computer readable storage medium and a computer program mechanism embedded therein. The computer program mechanism comprises instructions for performing any of the methods disclosed herein. In one exemplary embodiment, the computer program mechanism comprises instructions for receiving a submitted search query from a search requester and instructions for obtaining a first plurality of search results relevant to the submitted search query from a document index, where each search result in the first plurality of search results comprises (i) a source document or a reference to a source document and (ii) a static graphic representation of the source document, where the static graphic representation of the source document was obtained from the source document at a time before the submitted search query was received. The computer program mechanism in the exemplary embodiment further comprises instructions for displaying the static graphic representation of the source document of a first search result in the first plurality of search results in a center position of a graphic output device as well as instructions for displaying the static graphic representation of the source document of a second search result in the first plurality of search results in a first off-center position of the graphic output device, where the static graphic representation of the source document of the second search result is displayed rotated about a first axis of rotation that lies between the center position and the first off-center position of the graphic output device.

Another aspect of the present disclosure provides a computer, comprising a main memory, a processor, and a program, stored in the main memory and executed by the processor, the program including instructions for carrying out any of the methods disclosed herein.

Still another aspect of the present disclosure provides a computer, comprising a main memory, a processor; and a program, stored in the main memory and executed by the processor. The program includes instructions for receiving a submitted search query from a search requester. The program further includes instructions for obtaining a first plurality of search results relevant to the submitted search query from a document index, where each search result in the first plurality of search results comprises (i) a source document or a reference to a source document and (ii) a static graphic representation of the source document, where the static graphic representation of the source document was obtained from the source document at a time before the submitted search query was received. The program further includes instructions for displaying the static graphic representation of the source document of a first search result in the first plurality of search results in a center position of a graphic output device. The program further includes instructions for displaying the static graphic representation of the source document of a second search result in the first plurality of search results in a first off-center position of the graphic output device, where the static graphic representation of the source document of the second search result is displayed rotated about a first axis of rotation that lies between the center position and the first off-center position of the graphic output device.

Still another aspect of the present disclosure is a system for providing search results responsive to a search query. The system comprises means for receiving a submitted search query from a search requester. The system further comprises means for obtaining a first plurality of search results relevant to the submitted search query from a document index, where each search result in the first plurality of search results comprises (i) a source document or a reference to a source document and (ii) a static graphic representation of the source document, where the static graphic representation of the source document was obtained from the source document at a time before the submitted search query was received. The system further comprises means for displaying the static graphic representation of the source document of a first search result in a center position of a graphic output device. The system further comprises means for displaying the static graphic representation of the source document of a second search result in a first off-center position of the graphic output device, where the static graphic representation of the source document of the second search result is displayed rotated about a first axis of rotation that lies between the center position and the first off-center position.

### 4. BRIEF DESCRIPTION OF THE DRAWINGS

FIG. 1 illustrates a system in accordance with an aspect of the present disclosure.

FIG. 2 illustrates a search query prompt for searching one or more document repositories in accordance with an embodiment of the present disclosure.

FIG. 3 illustrates a search query prompt in accordance with an embodiment of the present disclosure, in which a partial search query has been entered, and responsive thereto, suggested vertical categories have been provided.

FIG. 4 illustrates a search query prompt in accordance with an embodiment of the present disclosure, in which a more complete search query has been entered relative to FIG. 3, and responsive thereto, updated suggested vertical categories have been provided.

FIG. 5 illustrates a search query prompt in accordance with an embodiment of the present disclosure, in which a completed search query has been entered, and responsive thereto, updated suggested vertical categories have been provided in accordance with an aspect of the present disclosure.

FIG. 6 illustrates displaying the static graphic representation of a source document of a first search result from the search query of FIG. 5 in a center position of a graphic output device and displaying the static graphic representation of the source document of a second search result from the search query of FIG. 5 in a first off-center position of the graphic output device, where the static graphic representation of the source document of the second search result is displayed rotated about a first axis of rotation that lies between the center position and the first off-center position, in accordance with an aspect of the present disclosure.

FIG. 7 illustrates how, responsive to a selection of the static representation of the source document of the first search result of FIG. 6 in the center position, the size of the static graphic representation of the source document is enlarged in accordance with an aspect of the present disclosure.

FIG. 8 illustrates how, responsive to a selection of the static graphic representation of the source document of the second search result in the first off-center position of FIG. 7, (i) the static graphic representation of the source document of the first search result is shifted to a second off-center position, thereby causing the static graphic representation of the source document of the first search result to be displayed at the second off-center position rotated about a second axis of rotation that lies between the center position and the second off-center position, (ii) the static graphic representation of the source document of the second search result is shifted to the center position, thereby causing the static graphic representation of the source document of the second search result to be displayed at the center position in a manner that is no longer rotated about the first axis of rotation, and (iii) the static graphic representation of the source document of a third search result is displayed in the first off-center position, where the static graphic representation of the source document of the third search result is displayed rotated about the first axis of rotation that lies between the center position and the first off-center position.

FIG. 9 illustrates the automatic transformation, without user input, of the static graphic representation of a source document of a search result to a live impression from the source document in accordance with an aspect of the disclosure.

FIGS. 10 and 11 illustrate the progression through static graphic representations in response to user input in accordance with an aspect of the disclosure.

FIG. 12 illustrates how, responsive to a selection of a static representation of the source document of a search result in the center position of the graphic output device, the static graphic representation of the source document is flipped from a first side to a reverse side so that the reverse side of the static graphic representation is displayed.

FIG. 13 illustrates the architecture of a vertical index in accordance with one embodiment of the present disclosure.

FIG. 14 illustrates an exemplary method in accordance with an embodiment of the present disclosure.

Like reference numerals refer to corresponding parts throughout the several views of the drawings.

### 5. DETAILED DESCRIPTION

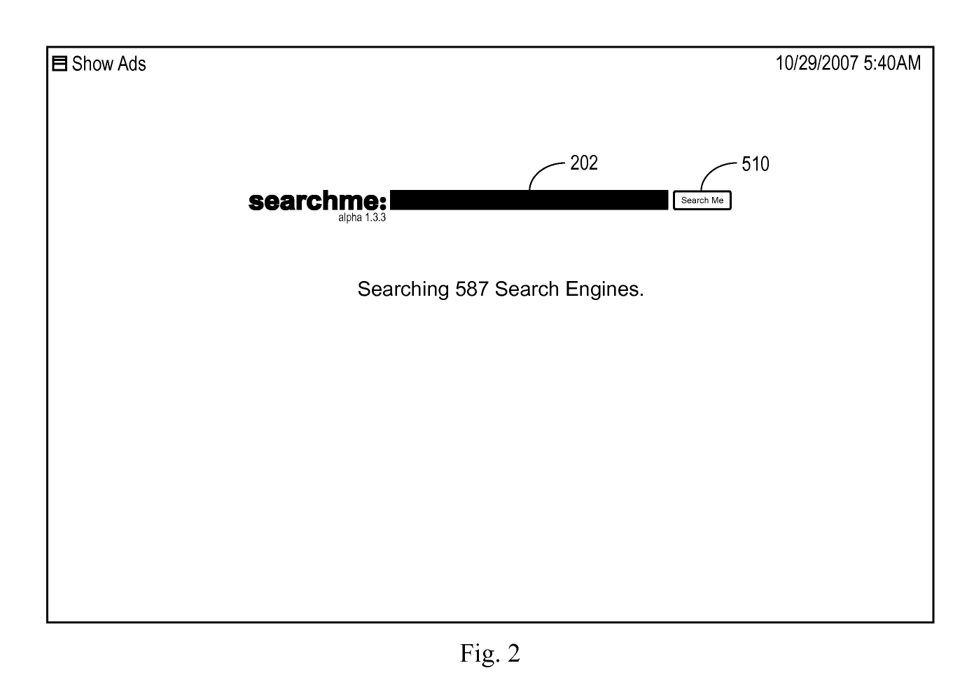

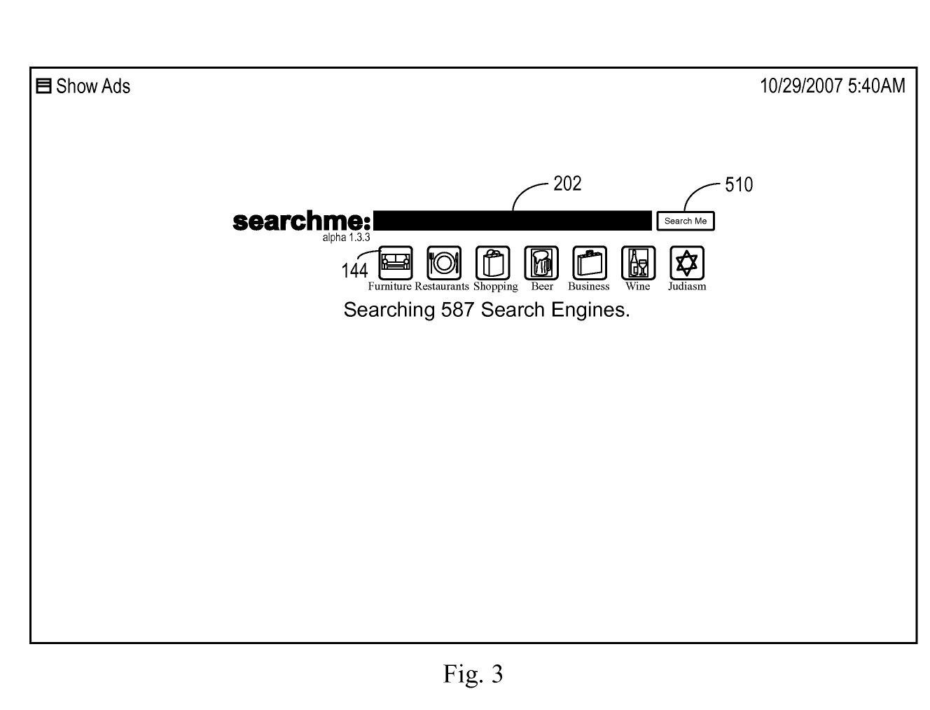

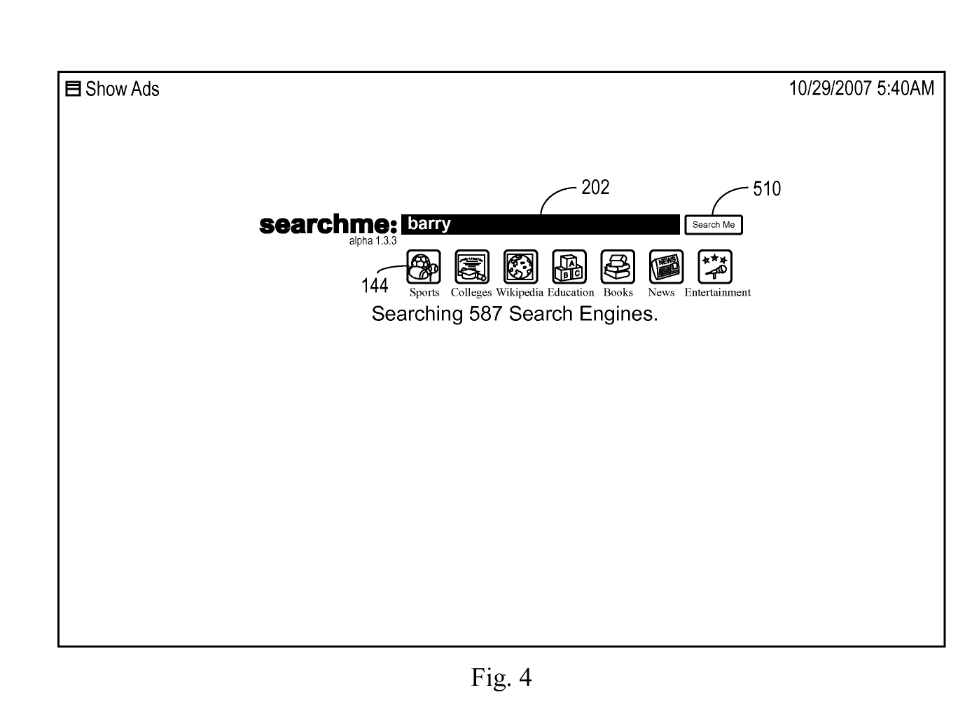

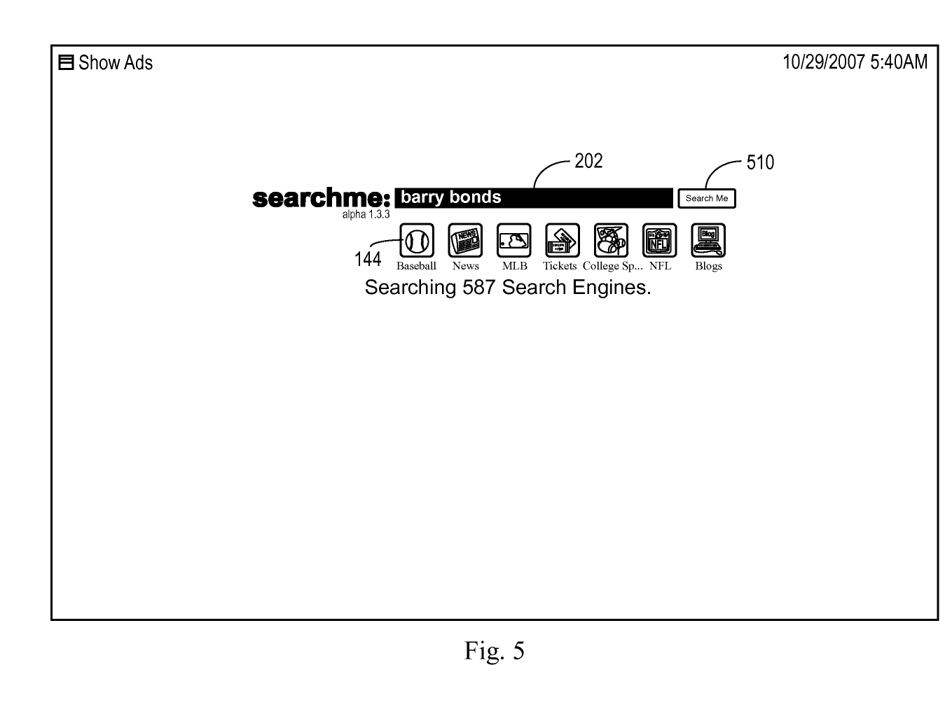

The present disclosure details novel advances over known search engines. A search query or a partial search query is submitted to a search engine. Upon receiving the search query or partial search query, the search engine identifies vertical collections in a vertical collection index 442 that are relevant to the search query. The names of the candidate vertical collections are then returned to a client computer where they are displayed. For example, consider FIG. 2, which comprises a prompt 202 for a search query. Turning to FIG. 3, a search requester enters the partial search query “bar” into prompt 202. In response, the search engine returns seven vertical collections 144 that match the partial search query: furniture, restaurants, shopping, beer, business, wine, and Judaism. The user can select one of the vertical collections 144 from FIG. 3 and proceed to search the vertical collection 144 with the original search expression or new search expressions. Alternatively, the user can continue typing in a search query. Alternatively still, the user can press the “SearchMe” button 510 and search a document index that represents the entire Internet or intranet with the search expression “bar.” Turning to FIG. 4, the search requester chooses to complete the expression “bar” so that it reads “barry.” In response, the search engine returns seven vertical collections that match the updated search query: sports, colleges, Wikipedia, education, books, news, and entertainment. The user can select one of the vertical collections 144 from FIG. 4 and proceed to search the vertical collection with the original search expression or new search expressions. Alternatively, the user can continue typing in a search query. Alternatively still, the user can press the “SearchMe” button 510 and search a document index that represents the entire Internet or intranet with the search expression “barry.” Turning to FIG. 5, the search requester elects to complete the search expression “barry” so that it reads “barry bonds.” In response, the search engine returns seven vertical collections 144 that match the updated search query: baseball, news, major league baseball (MLB), tickets, college sports, NFL, and blogs. At this point, the user can either (i) select the “SearchMe” button 510 and search a document index representative of the entire Internet and/or intranet, (ii) select from among the seven listed vertical collections 144 and search the vertical collection or (iii) revise the search expression.

As set forth above, in some embodiments, vertical collections are used rather than an index that represents the entire Internet. A “vertical collection” comprises a set of documents (e.g., URLs, websites, etc.) that relate to a common category. For example, web pages pertaining to sailboats constitute a “sailboat” vertical collection. Web pages pertaining to car racing constitute a “car racing” vertical collection. In some embodiments, users search a vertical collection so that only documents relevant to the category or categories represented by the vertical collection are returned to the user. Advantageously, the present disclosure provides systems and methods for helping a searcher identify the right vertical collection to search. In some embodiments, users search a document index representative of the entire Internet or intranet rather than a vertical collection.

Thus, as illustrated, an aspect of the present disclosure automatically provides a user with a list of candidate vertical collections 144 that can be used as the target of a user directed search query. By using the systems and methods detailed in the present disclosure, a user can search a target vertical collection for documents related to a search query with a minimal amount of effort needed to select the target vertical collection 144 from among a list of candidate vertical collections. More information on vertical collection suggestion technology that can be used in the systems and methods described herein is disclosed in United States Patent Publication No. 20070244863 entitled “Systems and Methods for Performing Searches within Vertical Domains” and United States Patent Publication No. 20070244862 entitled “Systems and Methods for Ranking Vertical Domains,” each of which is hereby incorporated by reference herein in its entirety.

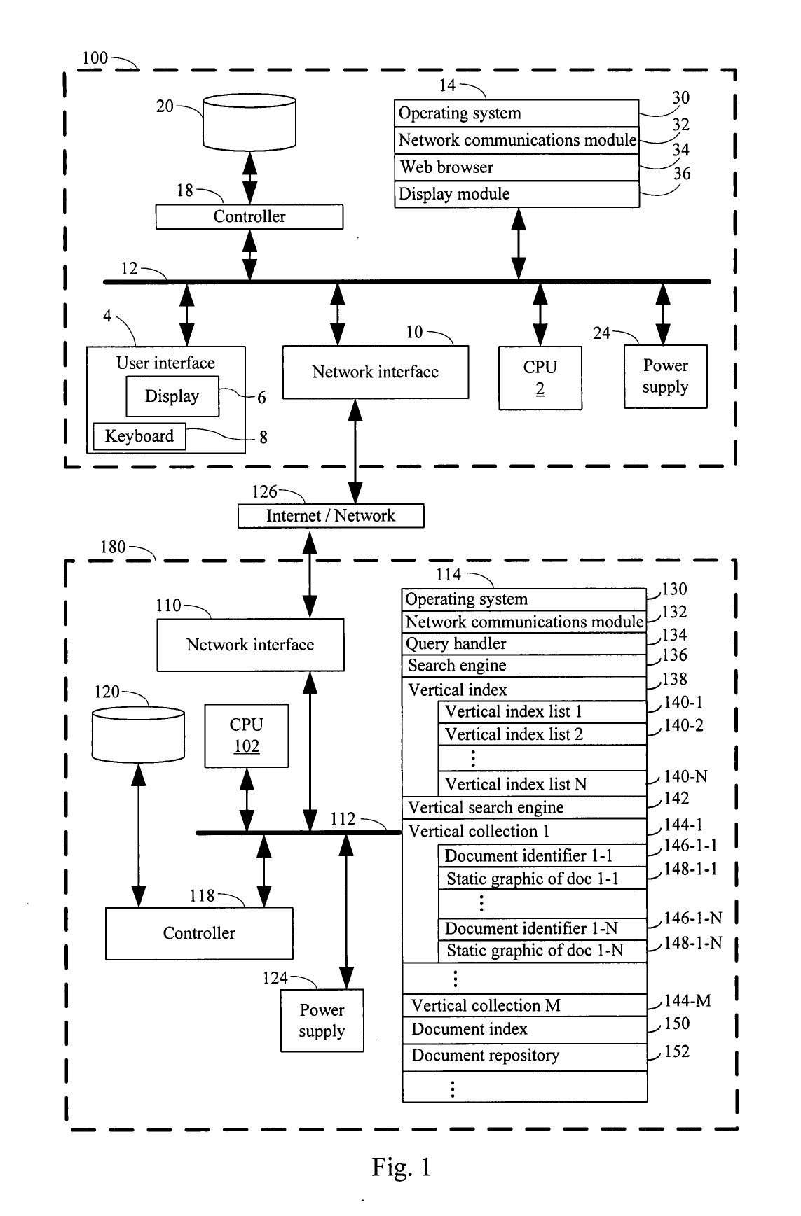

Now that an overview of the novel search query process and its advantages have been provided, a more detailed description of a system in accordance with the present application is described in conjunction with FIG. 1. FIG. 1 illustrates a vertical search engine server 180 in accordance with one embodiment of the present disclosure. In some embodiments, vertical search engine server 180 is implemented using one or more (not shown) computer systems. It will be appreciated by those of skill in the art that search engines designed to process large volumes of vertical search queries, such as search engine server 180, may use complicated computer architectures not shown in FIG. 1. For instance, a front end set of servers may be used to receive and distribute search queries from numerous client 100s among a set of back-end servers that actually process the search queries. In such a system, vertical search engine server 180 as shown in FIG. 1 would be one such back-end server.

Vertical search engine 180 will typically have one or more processing units (CPU's) 102, a network or other communications interface 110, a memory 114, one or more magnetic disk storage devices 120 accessed by one or more controllers 118, one or more communication busses 112 for interconnecting the aforementioned components, and a power supply 124 for powering the aforementioned components. Data in memory 114 can be seamlessly shared with non-volatile memory 120 using known computing techniques such as caching. Memory 114 and/or memory 120 can include mass storage that is remotely located with respect to the central processing unit(s) 102. In other words, some data stored in memory 114 and/or memory 120 may in fact be hosted on computers that are external to vertical search engine 180 but that can be electronically accessed by vertical search engine over an Internet, intranet, or other form of network or electronic cable (illustrated as element 122 in FIG. 1) using network interface 110.

Memory 114 preferably stores:
an operating system 130 that includes procedures for handling various basic system services and for performing hardware dependent tasks;
a network communication module 132 that is used for connecting vertical search engine 180 to various client computers such as client computers 100 (FIG. 1) and possibly to other servers or computers via one or more communication networks, such as the Internet, other wide area networks, local area networks (e.g., a local wireless network can connect the client computers 100 to vertical search engine 180), metropolitan area networks, and so on;
a query handler 134 for receiving a search query from a client computer 100;
a search engine 136 for searching either a selected vertical collection 144 or a document index 150, where document index 150 represents the entire Internet or an intranet, for documents related to a search query and for forming a group of ranked documents that are related to the search query;
an optional vertical index 138 comprising a plurality of vertical indexes 140, where each vertical index is an index of a corresponding vertical collection 144;
an optional vertical search engine 142, for searching optional vertical index 138 for one or more vertical index lists 140 that are relevant to a given search query;
an optional plurality of vertical collections 144, each optional vertical collection 144 comprising a plurality of document identifiers 146 and, for each respective document identifier 146, a static graphic representation 148 of the source URL for the document represented by the respective document identifier 146;
a document index 150 comprising a list of terms, a document identifier uniquely identifying each document associated with terms in the list of terms, and the scores of these documents; and
a document repository 152 comprising a source URL or a reference to a source URL for each document in the document repository and (ii) a static graphic representation of the source URL for each document in the document repository.

Vertical search engine 180 is connected via Internet/network 122 to one or more client devices. FIG. 1 illustrates the connection to only one such client device 100. However, in practice, vertical search engine 180 can be connected to 10 or more client devices 100, 100 or more client devices 100, more typically 1000 or more client devices, more typically still 10,000 or more client devices, and more typically still, 100,000 or more client devices. In typical embodiments, a client device 100 comprises:
one or more processing units (CPU's) 2;
a network or other communications interface 10;
a memory 14;
one or more magnetic disk storage devices 20 accessed by one or more controllers 18;
a user interface 4, the user interface 4 including a display 6 and a keyboard 8;
one or more communication busses 12 for interconnecting the aforementioned components; and
a power supply 24 for powering the aforementioned components.
   In some embodiments, data in memory 14 can be seamlessly shared with non-volatile memory 20 using known computing techniques such as caching. In some embodiments the client device 100 does not have a magnetic disk storage device. For instance, in some embodiments, the client device 100 is a portable handheld computing device and network interface 10 communicates with Internet/network 126 by wireless means.

Memory 14 preferably stores:
an operating system 30 that includes procedures for handling various basic system services and for performing hardware dependent tasks;
a network communication module 32 that is used for connecting client device 100 to vertical search engine 180;
a web browser 34 for receiving a search query from client computer 100; and
a display module 36 for instructing the web browser 34 on how to display search results relevant to a submitted search query.

The methods of the present disclosure begin before a search query is received by query handler 134. Document index 150 is constructed by scanning documents on the Internet and/or intranet for relevant search terms. An exemplary document index 152 is illustrated below:

| Term | Document Identifier |
|---|---|
| term 1 | docID₁ₐ, . . . , docID₁ₓ |
| term 2 | docID₂ₐ, . . . , docID₂ₓ |
| term 3 | docID₃ₐ, . . . , docID₃ₓ |
| . | |
| . | |
| . | |
| term N | docID_{Na}, . . . , docID_{Nx} |

In some embodiments, document index 150 is constructed by conventional indexing techniques. Exemplary indexing techniques are disclosed in, for example, United States Patent publication 20060031195, which is hereby incorporated by reference herein in its entirety. By way of illustration, in some embodiments, a given term may be associated with a particular document when the term appears more than a threshold number of times in the document. In some embodiments, a given term may be associated with a particular document when the term achieves more than a threshold score. Criteria that can be used to score a document relative to a candidate term include, but are not limited to, (i) a number of times the candidate term appears in an upper portion of the document, (ii) a normalized average position of the candidate term within the document, (iii) a number of characters in the candidate term, and (iv) a number of times the document is referenced by other documents. High scoring documents are associated with the term. In preferred embodiments, document index 150 stores the list of terms, a document identifier uniquely identifying each document associated with terms in the list of terms, and the scores of these documents. In some embodiments, the document identifier uniquely identifying each document is a uniform resource location (URL). Those of skill in the art will appreciate that there are numerous methods for associating terms with documents in order to build document index 150 and all such methods can be used to construct document index 150 of the present invention.

There is no limit to the number of terms that may be present in document index 150. Moreover, there is no limit on the number of documents that can be associated with each term in document index 150. For example, in some embodiments, between zero and 100 documents are associated with a search term, between zero and 1000 documents are associated with a search term, between zero and 10,000 documents are associated with a search term, or more than 10,000 documents are associated with a search term within document index 150. Moreover, there is no limit on the number of search terms to which a given document can associate. For example, in some embodiments, a given document is associated with between zero and 10 search terms, between zero and 100 search terms, between zero and 1000 search terms, between zero and 10,000 search terms, or more than 10,000 search terms.

In the context of this application, documents are understood to be any type of media that can be indexed and retrieved by a search engine, including web documents, images, multimedia files, text documents, PDFs or other image formatted files, ringtones, full track media, and so forth. A document may have one or more pages, partitions, segments or other components, as appropriate to its content and type. Equivalently a document may be referred to as a “page” and/or a “web page” as commonly is used to refer to documents on the Internet. No limitation as to the scope of the invention is implied by the use of the generic term “documents.” In the present disclsoure, there are many documents indexed. Typically, there are more than one hundred thousand documents, more than one million documents, more than one billion documents, or even more than one trillion documents present in document index 150.

In a preferred embodiment, for each document referenced by document index 150, vertical search engine server 180 stores (i) the source document or a reference to the source document and (ii) a static graphic representation of the source document, where the static graphic representation of the source document. In some embodiments, the reference to the source document is stored in document index 150 and the static graphic representation of the source document is stored in document repository 152. In some embodiments, the reference to each source document tracked by vertical search engine server 180 and the static graphic representation of the each source document tracked by vertical search engine server 180 is stored in document index 150. In some embodiments, the reference to each source document tracked by vertical search engine server 180 and the static graphic representation of the each source document tracked by vertical search engine server 180 is stored in document repository 152.

In some embodiments, of the present application, vertical collections 144 are used. Vertical collections 140 are constructed using documents in document index 150 that pertain to a particular category. For example, one vertical collection 144 may be constructed from documents indexed by document index 150 that pertain to movies, another vertical collection 144 may be constructed from documents indexed by document index 150 that pertain to sports, and so forth. Vertical collections 144 can be constructed, merged, or split in a relatively straightforward manner by a vertical engine server system operator. In some embodiments, there are hundreds of vertical collections 144 set up in this manner. In some embodiments, there are thousands of vertical collections 144 set up in this manner.

Once document index 150 has been constructed, it is possible to construct vertical index 138. To accomplish this, in some embodiments, each vertical collection 450 is inverted. Recall from FIG. 1, that each vertical collection 144 has the form:

Vertical collection (V₁)

DocId₁₋₁
Static Graphic DocId₁₋₁
DocId₁₋₂
Static Graphic DocId₁₋₂
.
.
.
DocId_{1-P}
Static Graphic DocId_{1-P}

In some embodiments, each DocId in the vertical collection 146 further includes a document quality score. Inversion of each of the vertical collections 144 and the merging of each of these inverted vertical collections leads to an inverted document-vertical index having the following data structure:

### Inverted Document-Vertical Index

| Document | Associated vertical |
|---|---|
| identifiers | collections 144 |
| DocId₁₋₁ | Vₐ, . . . , Vₓ |
| DocId₁₋₂ | V_{b}, . . . , V_{y} |
| . | |
| . | |
| . | |
| DocId_{1-P} | V_{c}, . . . , V_{z} |
| DocId₂₋₁ | V_{d}, . . . , Vₐₐ |
| . | |
| . | |
| . | |

Thus, for each given document in document index 150, a list of vertical collections 144 associated with the given document are provided in the inverted document-vertical index. There can be several vertical collections 144 associated with any given document. Further, there is no requirement that each document be associated with a unique set of vertical collections 144.

With the inverted document-vertical index, it is now possible to create vertical index 138 by substituting the document identifiers in document index 150 with the corresponding vertical collections associated with such document identifiers as set forth in the inverted document-vertical index. In one approach, this is done by scanning document index 150 on a termwise basis, and collecting the set of vertical collections 144 that are associated with the documents that are, themselves, associated with each term as set forth in the inverted document-vertical index. For example, consider a term 1 in the exemplary document index 150 presented above. According to document index 150, term 1 is associated with docID₁ₐ, . . . , docID₁ₓ. Thus, for each respective docIDᵢ in the set docID₁ₐ, . . . , docID₁ₓ, the inverted document-vertical index is consulted to determine which vertical collections 144 are associated with the respective docIDᵢ. Each of these vertical collections 144 are then associated with term 1 in order to construct a vertical index list 140 for term 1. Thus, starting with the entry for term 1 in document index 150,

| | |
|---|---|
| term 1 | docID₁ₐ, . . . , docID₁ₓ |

the set of vertical collections associated with docID₁ₐ, . . . , docID₁ₓ are collected from the inverted document-vertical index in order to construct the vertical index list 140:

| | |
|---|---|
| term 1 | V₁, V₂, . . . , V_{N} |

where each of V₁, V₂, . . . , V_{N} is a vertical collection identifier that points to a unique vertical collection 144. This data structure is a vertical index list 140. As illustrated, a vertical index list 140 is a list of vertical collection identifiers of vertical collections 144 sharing a definable attribute (e.g., “term 1”). If term 1 was “vacation,” than vertical index list 140 contains the identifiers of the vertical collections 144 holding documents containing the word “vacation.” The predicate defining the list, “term 1” in the above example, is referred to as the “head term.”

By considering all the terms in a collection of terms, vertical index 138 is constructed. There may be a large number of terms in the collection of terms. Vertical index 138 comprises vertical index lists 140, along with an efficient process for locating and returning the vertical index list 140 corresponding to a given attribute (search term). For example, a vertical index 138 can be defined containing vertical index lists 140 for all the words appearing in a collection. Vertical index 138 stores, for each given word in the collection, a vertical index list 140 of those vertical collections 144. Each such vertical collection 144 in the vertical index list 140 for the given word holds at least some documents containing the given word.

Referring to FIG. 13, a specific structure for vertical index 138 is provided in accordance with one embodiment of the present invention. In this embodiment, vertical index 138 comprises a hash lookup table and a vertical index list storage component. The hash lookup table contains pointers or file offsets that pinpoint the location of an individual vertical index list 140. A hash of a given head term (search term) provides the correct offset to corresponding list of vertical collections 144 that hold documents for the given head term. For example, consider the case in which the head term is “vacation.” The head term is hashed to give, in this example, the offset 03. A table lookup at offset 03 in vertical index 138 gives the list of identifiers [vertId₃₁, vertId₃₂, vertId₃₃, vertId₃₄, ] that correspond to the head term “vacation.” Each identifier in the set [vertId₃₁, vertId₃₂, vertId₃₃, vertId₃₄, . . . ] corresponds to a vertical collection 144 that contains documents with the “vacation” head term. Continuing to refer to FIG. 13, the vertical index lists 140 are shown as having different lengths because that is the usual case. In some embodiments, a term specific score is associated with each vertical identifier in each vertical index list 140 as described in more detail below.

Steps for constructing a vertical index 138 have been detailed above. The vertical index 138 includes, for each respective head term in a collection of head terms, the list of vertical collections 144 having documents that contain the respective head term. To optimize vertical index 138, additional steps are taken in some embodiments to rank each vertical collection 144 referenced in each respective vertical index list 140 so that only the most significant vertical collections 144 are returned for any given search query. Thus, for each respective head term (t) represented in vertical index 138, each vertical collection (v) listed in the vertical index 138 for the respective head term is scored with the respect to the head term to give a score(t,v). The score for a vertical collection 144, given a specific head term score(t,v), can be computed many different ways. In some embodiments, the score for a vertical collection 144, given a specific head term (score(t,v)), is computed by summing over all documents in the vertical collection 144 as follows:

$$score ( t , v ) = [ {\sum }_{d ∈ V} score ( t , d ) ] \cdot w ( d , v ) \qquad ( I )$$

where score(t,d) is the score for a document in the vertical collection 144 and w(d,v) is some weight assigned to the vertical collection 144 that contains the document.

In some embodiments, w(d,v) is a weight that upweights those vertical collections 144 that have the highest frequency of the given head term. In other words, in such embodiments, w(d,v) is higher for a first vertical collection 144 that has documents with a higher incidence of head term (t) than a second vertical collection 144 that has documents with a lower incidence of head term (t). In some embodiments, w(d,v) is a weight that upweights those vertical collections 144 that have a high prevalence of the head term in the highest ranked documents within such vertical collections 144. In other words, in such embodiments, w(d,v) is higher for a first vertical collection 144 that has a higher incidence of head term (t) within high ranked documents of the first vertical collection 144 than a second vertical collection 144 that has a lower incidence of head term (t) within high ranked documents of the second vertical collection 144. Here, high ranked documents refer to those documents that have received a high rank in document index 140. Methods by which a high rank is assigned to certain documents 466 are well known in the art. One criterion for ranking a document, is for example, to asses how many other documents reference the given document. The idea behind such a ranking scheme is that the more documents that reference the given document, the more interesting the given document must be. See, for example, Dominich and Skrop, 2004, Journal of the American Society for Information Science and Technology 56, pp. 63-69, which is hereby incorporated by reference herein in its entirety. Several other criteria and methods for ranking documents are known to those of skill in the art and all such criteria and methods can be used to rank documents in the present invention. Then, such the rankings of such documents in document index 150 is used to assign a score(t,v) for the vertical collections 144 that contain such documents. Alternatively, in less preferred embodiments, documents can be ranked within vertical collections independently of index document index 150 using the same criteria and methods generally used to rank documents in the art. In some embodiments w(d,v) is not used to compute score(t,v). That is, in some embodiments, there is no w(d,v). In some embodiments, w(d,v) for a given vertical collection 144 is a function of the popularity of the vertical collection 144, an aggregation of the link density for documents within the vertical collection 144, or any other criterion that is normally used to evaluate the quality of documents.

In some embodiments

$$score ( t , d ) = ( A + log ( f ( d , t ) ) ) \cdot log ( B + \frac{f ( N )}{v ( t )} ) \qquad ( II )$$

where f(d,t) is the number of times the head term (t) occurs in document (d) of vertical collection 144, and f(N) is a function of the number of vertical collections 144 accessible to vertical search engine 142 (whether such vertical collections are stored in memory 114 and/or accessible via network interface 110). In some embodiments f(N) is simply Mᵥ, the number of vertical collections 144 stored in memory 114 and/or available via network interface 110). In some embodiments f(N) is log(Mᵥ) or some other function of Mᵥ such as the root of Mᵥ. In formula (II), v(t) is the number of vertical collections 144 containing head term (t). In practice, v(t) is the number of vertical collections 144 that are in the vertical index list 140 for head term (t). Also, in formula (II), A and B are both equal to 1 in some embodiments. In other embodiments, A and B are the same or different constant numbers. In some embodiments A is larger than B. In some embodiments A is smaller than B. In some embodiments A is equal to B. Other formulas for score(t,d) are possible. For example, in some embodiments,

score(t, d)=f(d, t). (III)

where f(d,t) is the number of times the head term (t) occurs in document (d) of vertical collection 144.

Substituting formula (II) into formula (I) and rearranging, in some embodiments:

$$score ( t , v ) = log ( B + \frac{f ( N )}{v ( t )} ) {\sum }_{d ∈ V} ( A + log ( f ( d , t ) ) ) \cdot w ( d , v ) \qquad ( IV )$$

for embodiments where a global w(d,v) is applied to each document in an entire vertical collection 144, and

$$score ( t , v ) = log ( B + \frac{f ( N )}{v ( t )} ) {\sum }_{d ∈ V} ( A + log ( f ( d , t ) ) ) \cdot w ( d , t ) \qquad ( V )$$

for embodiments where a w(d,t) is applied to each document based on the identity of term (t).

In some embodiments, score(t,v) as expressed in either formula (IV) or (V) is part of an overall score (scoreₒᵥ) for a vertical collection 144 given a term (t) having the form:

μ₁*score₁(t,v)+μ₂*score₂(t,v) (VI)

where, score₂ is either score(t,v) of formula (IV) and (V) and score₁(t,v) has the form:

score₁(t,v)=score for head term t in vertical v=(C+log(f(v,t)))*log(D+f(N)/v(t)) (VII)

where f(v,t) is the number of documents in vertical collection (v) containing term (t), f(N) is a function of the number of vertical collections tracked by memory 114 (e.g., N, the number of vertical collections tracked by memory 1 14, log(N), root of N, etc.), v(t) is the number of vertical collections 144 in the vertical index list 140 of term (t), and C and D are constants. C and D are both equal to 1 in some embodiments. In other embodiments, C and D are the same or different constant numbers. In some embodiments C is larger than D. In some embodiments C is smaller than D. In formula (VI), μ₁ and μ₂ are terms that can be independently adjusted. In typical embodiments, μ₁ and μ₂ are constant values. These values can be the same or different. In some embodiments, μ₁ is zero. In some embodiments μ₁ is a constant value that is less than μ₂. In some embodiments, μ₁ is a constant value that is greater than μ₂.

Referring to FIGS. 14A and 14B, an exemplary method in accordance with one embodiment of the present disclosure is described. The method details the steps taken by vertical search engine server 180 to interactively provide a user with search results responsive to a user query.

Step 1202. In step 1202, a search query is received from client computer 100. A search query typically comprises a list of one or more keywords, possibly joined by the Boolean operators AND, OR, as well as NOT, and optionally grouped with parentheses or quotes. Examples of vertical search queries include: (i) “Florida discount vacations,” (ii) “The President of the United States,” “(car OR automobile) AND (transmission OR brakes)”, and “boat.” A search query comprises any combination of alphanumeric and/or nonalphanumeric characters. Referring to FIG. 2, a search query is the contents of prompt 202 at a given time point. In some embodiments, the search query is in the form of an http request.

Step 1204. In step 1204, a determination is made as to whether a user has selected a vertical collection 144. Referring to FIG. 2, a user can, for example, select an icon for a vertical collection 144 at any time by selecting any of the icons representing vertical collections 144 that are displayed. In typical embodiments, no icons for vertical collections 144 are displayed when prompt 202 is empty and, thus, at the stage when prompt 202 is empty, the user cannot select a vertical collection 144 in such embodiments. In some embodiments, icons for popular and/or sponsored vertical collections 144 are displayed when prompt 202 is empty. If a user has not selected a vertical collection (1204-No), then control passes to step 1205. If a user has selected a vertical category (1204-Yes), then control passes to step 1260 (FIG. 14B).

Step 1205. In step 1205, a determination is made as to whether a user has selected to make a search of a document index representative of the entire Internet (e.g., referring to FIG. 3, that the user has pressed button 510). Referring to FIG. 3, a user can, for example, select button 510 at any time. If a user has not selected to make a search of a document index representative of the entire Internet (1205-No), then control passes to step 1206. If a user has selected to make a search of a document index representative of the entire Internet (1205-Yes), then control passes to step 1280 (FIG. 14B).

Step 1206. In step 1206, the search query is decomposed into atomic vertical search queries. An atomic search query consists of a single term or predicate condition. For example, the search query “(car OR automobile) AND (transmission OR brakes)” includes the single terms “car”, “automobile”, “transmission”, “brakes” and the predicate conditions of precedence “( )”, AND, as well as OR.

Step 1208. In typical embodiments, only one of the atomic vertical search queries in the vertical search query will be new or altered. Thus, in step 1208, the atomic vertical search query that is new or has been altered is first identified. To illustrate, consider the case where the vertical search query in the last instance of step 1208 was “car OR auto” whereas in the current instance of step 1208, the vertical search query is “car OR automobile”. In step 1206, the vertical search query “car OR automobile” is broken down to the atomic vertical search queries “car” and “automobile.” The atomic vertical search query “car” remains unchanged relative to the last instance of step 1208 and therefore is not hashed in the new instance of step 1208. The atomic vertical search query “automobile”, on the other hand, had the form “auto” in the last instance of step 1208 and is therefore not hashed in the new instance of step 1208. In some embodiments, rather than rehashing the full atomic vertical search “automobile” the hash of “auto” from the previous instance of step 1208 is used and a cumulative hash is performed with the additional characters “mobile” in order to arrive at the full hash for “automobile” in the current instance of step 1208. In some embodiments, such cumulative hashing is not performed. Cumulative hashing is preferable in some embodiments so that recommended verticals collections 144 can be returned to client computer 100 before the user has had a chance to enter many more keystrokes into prompt 202. Thus, any technique that will speed up the computation of steps 1206 through 1212 is desirable.

In some embodiments atomic vertical search queries are not hashed. In such embodiments, vertical index 138 is not ordered by the hash values of atomic vertical search queries. In some embodiments, more than one atomic vertical search query within the vertical search query is new or has been altered. In such embodiments, each new or altered atomic vertical search query is separately hashed in step 1208. If a precursor expression is available for any of these altered atomic vertical search queries, the hash of such precursor expressions is used to speed up the hash of the corresponding altered atomic vertical search query.

Step 1210. In step 1210, the vertical index list 140 for each new or altered atomic vertical search query in the vertical query is identified. In embodiments where vertical index 138 is a hash table, such as illustrated in FIG. 13, this operation is a simple hash lookup using the respective hash of each new or altered atomic vertical search query. In some embodiments, a hash is not used to accomplish this operation. For example, in some embodiments, vertical index 138 is some other form of data structure that contains vertical indices 138, such as an array, list, stack, queue, tree, or database. Such data structures are described in Brookshear, Computer Science, 2003, Addison-Wesley, N.Y., which is hereby incorporated by reference in its entirety. In some embodiments, the vertical index lists 140 that correspond to atomic vertical search queries that are not new in the search query are already known from previous instances of step 1210 and are therefore not obtained in successive instances of step 1210. In some embodiments, the vertical index 1400 of each atomic vertical search query in the vertical search query is identified in each instance of step 1210. Regardless of the embodiment, upon completion of step 1210, the vertical index list 140 of each atomic vertical search query in the vertical search query is identified.

Step 1212. In step 1212, a list of recommended vertical collections 144 for the vertical search query from client computer 100 is composed. In the case where the search query includes only one atomic vertical search term, step 1612 simply involves extracting each of the names of the vertical collections 144 referenced in the vertical index 138 for the atomic vertical search term that was identified in step 1210. In the case where the vertical search term includes more than one atomic vertical search term, more work is required. Consider the case in which there are two atomic vertical search terms in a vertical search term query in which there is either no operator between the two search terms or the two search terms are joined by an “AND” operator. In this case, the names of the vertical collections 144 for each atomic vertical search term are first identified using the processes described above. So, if the atomic vertical search terms are term₁ and term₂, this operation results in the identification of the following:

| | |
|---|---|
| term₁ | VC₁₋₁, VC₁₋₂, . . . , VC_{1-N} |
| term₂ | VC₂₋₁, VC₂₋₂, . . . , VC_{2-M} |

Then, in order to identify a list of recommended vertical collections 144 in this instance, the intersection of each list of vertical collections 144 is taken in some embodiments of the present invention. This means that only those vertical collections 144 that are common to both vertical index lists 140 are included in the list of recommended vertical collections 144 in such embodiments. In some embodiments, in addition to the requirement that each recommended vertical collection be present in both index lists 140, each recommended vertical collection must have a minimum relevancy score(v,t).

Next consider the case in which two atomic vertical search terms are joined by an “OR” operator. Here, the union of the vertical collections 144 in the two vertical index lists 140 for the two search terms is taken. That is, vertical collections 144 that are in either vertical index list 140 are selected for inclusion in the list of names of candidate vertical collections 450 that are sent back to client computer 100 in response to entry of the partial search query. As used herein, a partial search query is any query entered into prompt 202 before a vertical suggestion 144 or the “SearchMe” prompt 510 has been selected by a user. In some embodiments the relevancy score for each vertical collection 144 in each selected vertical index list 140 is also used to determine which vertical collections 144 are selected for the list of names of candidate vertical collections 144. For example, in some embodiments, those vertical collections 144 that are represented in the vertical index list 140 of both atomic vertical search terms are summed. Because of this summing operation, there is a tendency for those vertical collections 144 that are represented in the vertical index list 140 of both atomic vertical search terms to appear in the list or recommended vertical collections 144 in such embodiments. However, it is still quite possible in such embodiments for vertical collections 144 that appear in only one of the two vertical index lists 140 to be recommended if such vertical collections 144 have a high score. The following example illustrates the point. Consider the vertical indexes 140 for term₁ and term₂ in which the quality or relevancy score of each vertical collection 144 has been computed and in which term₁ and term₂ are related by an “OR” operator:

| | |
|---|---|
| term₁ | VC₁₅₀(score_{150,t1}), VC₁₇₀(score_{170,t1}), VC₁₇₅(score_{175,t1}) |
| term₂ | VC₁₅₁(score_{151,t2}), VC₁₇₀(score_{170,t2}), VC₁₇₅(score_{175,t2}) |

Thus, for purposes of determining which vertical collections 144 are to be incorporated into the list of recommended vertical collections responsive to a given vertical search query, the following computations are made:

VC₁₅₀=score_{150,t1}

VC₁₇₀=score_{170, t1}+score_{170, t2}

VC₁₇₅=score_{175, t1}+score_{175, t2}

VC₁₅₁=score_{151, t2}

Here, VC₁₇₀ and VC₁₇₅ benefit from the summation of two scores whereas VC₁₅₀ and VC₁₅₁ each receive only one score. However, it is still quite possible that VC₁₅₀ or VC₁₅₁ may have a higher score than VC₁₅₀ and VC₁₅₁ and therefore be included in the list of recommended vertical collections 450. Each of the scores may be any of the scores described with respect to formulas (I) through (VII) above, or some other score that assigns vertical collection quality or relevance of a vertical collection to a given search term.

For two atomic vertical search terms joined by a NOT operator, those vertical collections 144 in the vertical index list 140 of the negated search term are subtracted from the list of vertical collections 144 in the vertical index list 140 associated with the non-negated search term to arrive at a recommended list of vertical collections for a given partial search request. To illustrate, consider the vertical index lists 140 for term₁ and term₂ in which the quality or relevancy score of each vertical collection 144 has been computed and in which term₁ and term₂ are related by a “NOT” operator:

| | |
|---|---|
| term₁ | VC₁₅₀(score_{150,t1}), VC₁₇₀(score_{170,t1}), VC₁₇₅(score_{175,t1}) |
| term₂ | VC₁₅₁(score_{151,t2}), VC₁₇₀(score_{170,t2}), VC₁₇₅(score_{175,t2}) |

Thus, in this case, only the vertical collection VC₁₅₀ would be selected for inclusion in the list of recommended vertical collections 144.

More complex logical expressions can be built using combinations of atomic vertical search queries joined by Boolean expressions such as AND, OR as well as NOT. Moreover, precedence can be introduced using parentheses. Those of skill in the art will appreciate that other forms of logic can be used to merge or split lists of vertical collections 144 in vertical index lists 140 in order to arrive at a final set of list of recommended vertical collections 144 for a given partial search query and all such forms of logic are within the scope of the present invention.

In some embodiments, the list of recommended vertical collections 144 contains a maximum number of vertical collections 144. For some partial search expressions, the number of vertical collections 144 identified does not exceed this maximum. However, for some search expressions, the number of vertical collections 144 identified does exceed the maximum possible number of recommended vertical collections 144. In such embodiments, the term-based relevancy score associated with each vertical collection 144 is used to determine which vertical collections are included in the recommendation list of vertical collections for a given vertical search query. Only top scoring vertical collections 144 are selected for the list.

Steps 1214-1218. The lookup performed by steps 1208 through 1212 is designed to be fast. In some embodiments, a recommended list of vertical collections 144 is returned to client computer 100 between each character stroke entered by a user into prompt 202. Correspondingly, in some embodiments, client computer 100 sends a new vertical search query each time the user enters a new character into prompt 202 of FIG. 3. In some embodiments, client computer 100 sends a new vertical search query each time an end of string signal is detected. Such an end of string signal is detected by client computer 100 in some embodiments when a pause in the typing of the user is detected. For example, referring to FIGS. 4 and 5, if there is a delay (e.g., a 1 second, a 2 second delay, a 3 second delay, etc.) between entering the “y” (FIG. 4) and the “b” (FIG. 5), then the end of string signal is detected by client computer 100 and the string “barry” is sent to the remote server (vertical engine server 180) as a partial search query. In some embodiments, an end of string signal is also detected when a space character or carriage return, or other designated character, is entered into prompt 202 by a user.

In some embodiments, a check is performed to determine whether an updated query has been received from client computer 100 (step 1214). For example, in some embodiments, a determination is made as to whether a new http request has arrived from the client computer 100 with an updated search query. If an updated search query has been received (1214-Yes), control is passed back to step 1204 without reporting the recommended vertical collections (step 1216). If a new or revised vertical search query has not arrived (1214-No), then the recommended vertical collections 144 are reported to client computer 100 where they are displayed (step 1218). In some embodiments, the recommended vertical collections 450 are reported to client computer 100 even when a new vertical search query has arrived from client computer 100.

In some embodiments, the list of recommended vertical collections that is returned to client computer 100 includes both the identity of the recommended vertical collections 144 (names) and a relevancy score for each vertical collection 144. Such relevancy scores are computed, for example using any of the scoring functions described with respect to formulas (I) through (VII) above, or any other scoring function that assesses the relevance of a vertical collection 144 to given search query. Upon completion of step 1218, control passes back to step 1202 in order to wait for a new or updated search query.

Step 1260. When a user selects a prompt for a vertical collection 144, the search query is made using the selected vertical collection 144. In step 1260, the selected vertical collection 144 is searched for those documents that are most relevant to the search query. In some embodiments, search engine 136 performs the search of the selected vertical collection 144. In some embodiments, a search engine that is specialized for only searching vertical collections 144 performs the search.

Step 1280. When a user elects to search a document index representative of the entire Internet (e.g., by selecting button 510 of FIG. 2), the search query is made using document index 150. Thus, in step 1280, document index 150 is searched by search engine 136 for those documents that are most relevant to the search query.

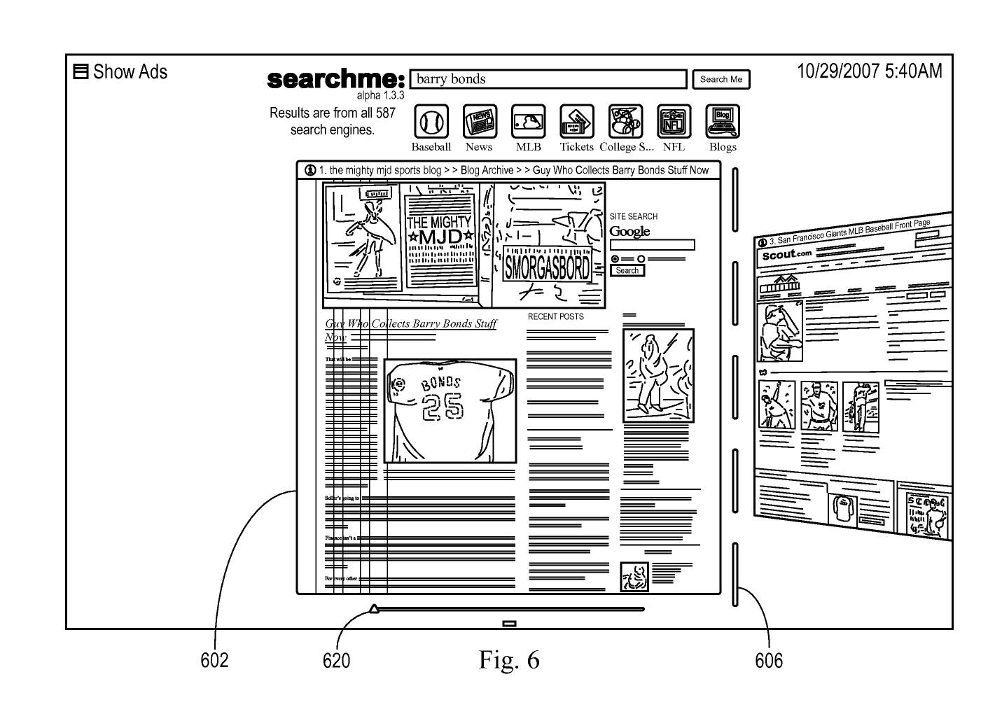

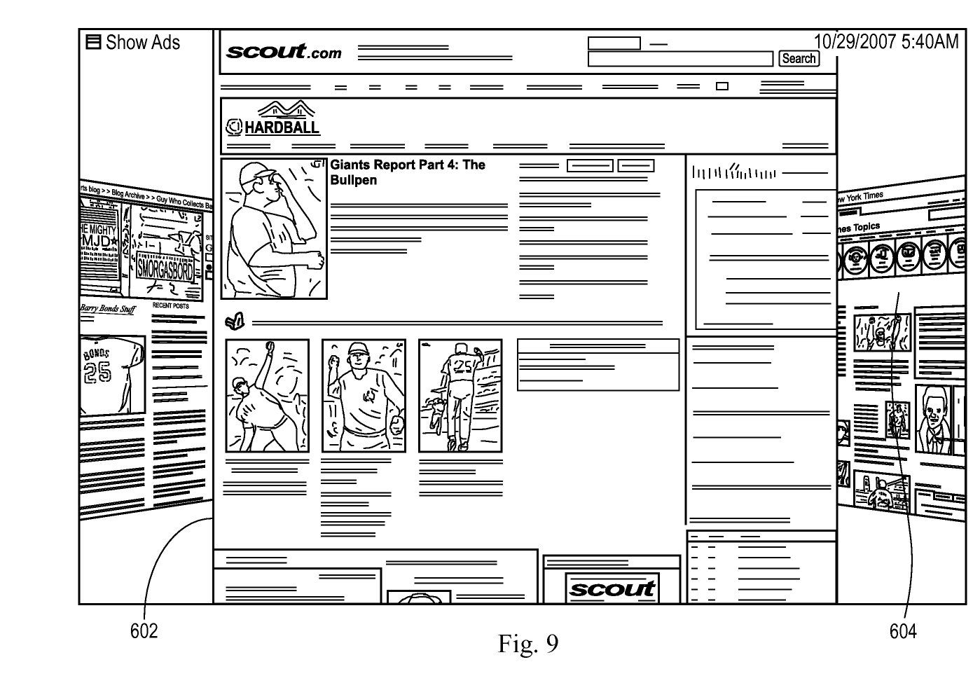

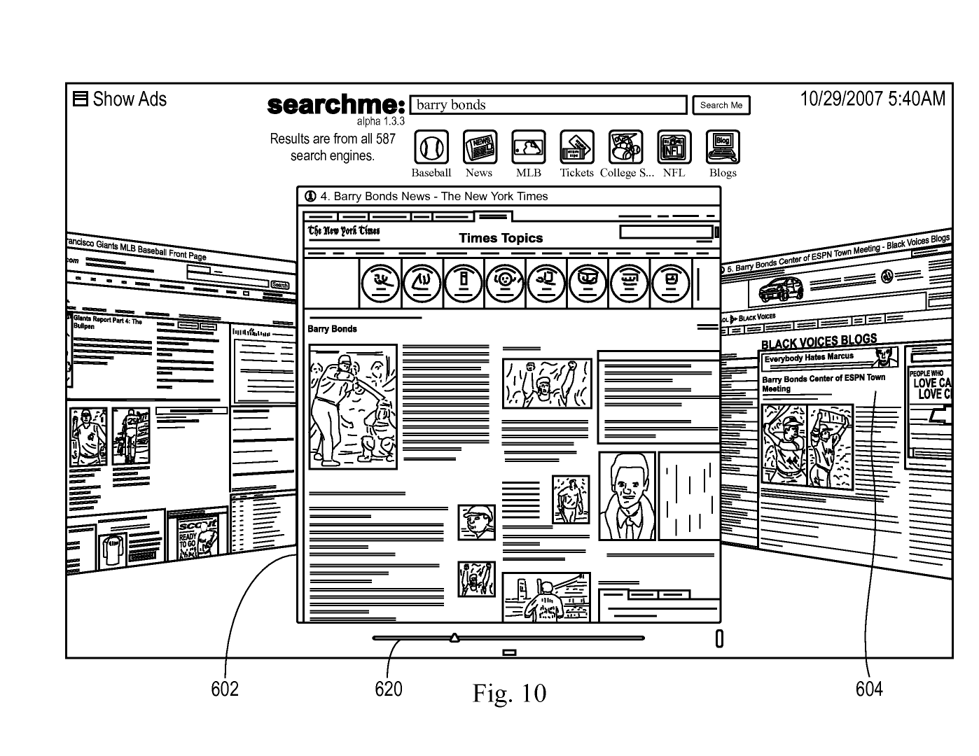

Step 1290. In step 1290, the high ranking documents are reported to client computer 100 where they are displayed, for example, as shown in FIGS. 6-12, in accordance with instructions provided from display module 36 to web browser 34. In some embodiments, display module 36 and web browser are, in fact, the same program. In some embodiments, display module 36 and web browser are different programs. Thus, in summary, a submitted search query is received from a search requester on a client computer 100. As described above, the search query is submitted to vertical search engine server 180. The vertical search engine server 180 searches a document index, such as document index 150 or a vertical collection 144 for documents relevant to the search query. The vertical search engine server 180 sends as plurality of search results relevant to the submitted search query to a client device 100. Referring to FIG. 1, in the case where the document index 150 was searched, each search result in the plurality of search results comprises (i) a source document or a reference to a source document 152 and (ii) a static graphic representation 154 of the source document, where the static graphic representation 154 of the source document was obtained from the source document at a time before the submitted search query was received. Continuing to refer to FIG. 1, in the case where a vertical collection was searched, each search result in the plurality of search results comprises (i) a source document or a reference to a source document 146 and (ii) a static graphic representation 148 of the source document, where the static graphic representation 148 of the source document was obtained from the source document at a time before the submitted search query was received. In the present disclosure, a document identifier 146 and a document identifier 152 have the same form. In typical embodiments, the only difference between the two types of document identifiers is that identifier 146 is in a vertical collection 144 whereas identifiers 152 are in the document index 150. Because of this, as used herein, the terms document identifier 146 and document identifier 152 are interchangeable. Document index 150 is representative of the entire Internet, meaning that it is not limited to a particular category of documents or a set of categories of documents in the manner that a vertical collection 144 is limited to a particular category of documents or a set of categories of documents. Likewise, in typical embodiments, the only difference between the two types of static graphics is that static graphic 148 is in a vertical collection 144 whereas static graphic 154 is in the document index 150. Because of this, as used herein, the terms static graphic (i.e., static graphic representation) 148 and static graphic (i.e., static graphic representation) 154 are interchangeable.

In the present disclosure, in accordance with step 1290 of FIG. 14B and referring to FIG. 6, the static graphic representation of the source document of a first search result in the plurality of search results is displayed in a center position 602 of a graphic output device 6 on the client 100. Furthermore, the static graphic representation of the source document of a second search result in the plurality of search results is displayed in a first off-center position 604 of the graphic output device 6. The static graphic representation of the source document of the second search result is displayed rotated (e.g., at least one degree out of the plane of the graphic output device 6, at least two degrees out of the plane of the graphic output device 6, at least three degrees out of plane of the graphic output device 6, at least five degrees out of plane of the graphic output device 6) about a first axis of rotation 606 that lies between the center position 602 and the first off-center position 604 of the graphic output device 6, for example, in the manner illustrated in FIG. 6.

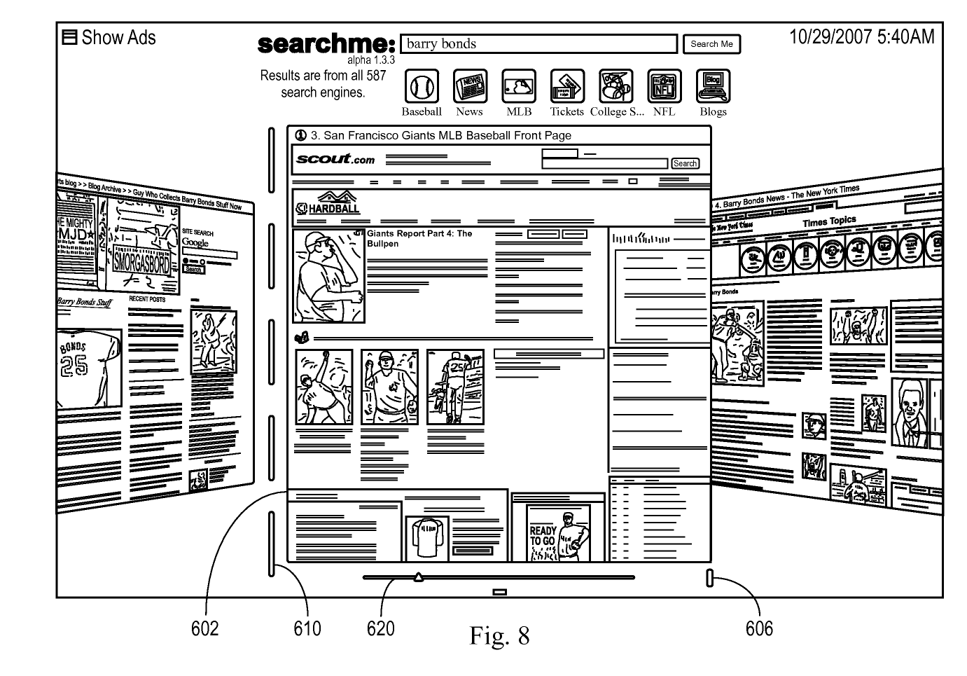

In some embodiments, responsive to a selection of the static graphic representation of the source document of the second search result in the first plurality of search results in the first off-center position 604, the second search result is shifted from the first off-center position 604 to the center position 606 as illustrated in the transition from FIG. 6 to FIG. 8. In FIG. 6, the second search result is in position 604. When a user clicks on the static image at position 604 (FIG. 6), the image is moved to the center position 602 as illustrated in FIG. 8.

In some embodiments, the transition from the display as seen in FIG. 6 to the display as seen in FIG. 8, in response to the selection of the graphic representation at the first off-center position 604, involves shifting the static graphic representation of the source document of the first search result to a second off-center position 608 of the graphic output device 6 (FIG. 8), thereby causing the static graphic representation of the source document of the first search result to be displayed at the second off-center position 608 rotated (e.g., at least one degree out of the plane of the graphic output device 6, at least two degrees out of the plane of the graphic output device 6, at least three degrees out of plane of the graphic output device 6, at least five degrees out of plane of the graphic output device 6) about a second axis of rotation 610 that lies between the center position 602 and the second off-center position 608 of the graphic output device 6. In some embodiments, the transition further involves shifting the static graphic representation of the source document of the second search result to the center position 602 of the graphic output device, thereby causing the static graphic representation of the source document of the second search result to be displayed at the center position 602 in a manner that is no longer rotated about the first axis of rotation 606. Further, the static graphic representation of the source document of a third search result in the first plurality of search results is displayed in the first off-center position 604 of the graphic output device, where the static graphic representation of the source document of the third search result is displayed rotated about the first axis of rotation 606 that lies between the center position 602 and the first off-center position 604 of the graphic output device. Of course, the first, second and third search result can be any set of three consecutive search results in the plurality of search results returned from vertical search engine server 180 in response to a search query.

Just as graphic representations can be shifted from the first off-center position 604, to the center position 602, and then to the second off-center position 608, the reverse is also true. When a user clicks on a graphic representation occupying the second off-center position 60, the graphic representation occupying the second off-center position 608 is shifted to the center position 602 and the graphic representation formally occupying the center position 602 is shifted to the first off-center position 604. Further, any graphic representation that had been placed in the second off-center position 608 before the graphic representation that had been moved to the center position exist, this graphic representation would be “uncovered” and visible in the second off-center position 608. Thus, in the above-identified manner, a user can easily view the graphic representation of search result hits in a seamless and efficient manner.

In a specific embodiment, responsive to a selection of the static graphic representation of the source document of the first search result in the second off-center position 608, the static graphic representation of the source document of the first search result is shifted to the center position 602, thereby causing the static graphic representation of the source document of the first search result to be displayed at the center position 602 in a manner that is no longer rotated about the second axis 610 of rotation that lies between the center position 602 and the second off-center position 608 of the graphic output device. Furthermore, the static graphic representation of the source document of the second search result is moved from its former location at the center position 602 to the first off-center position 604 of the graphic output device 6, thereby causing the static graphic representation of the source document of the second search result to be displayed at the first off-center position 604 in a manner that is rotated about the first axis of rotation 606. Consequently, the static graphic representation of the source document of the third search result formerly occupying in the first off-center position 604 of the graphic output device 6 is removed from view.

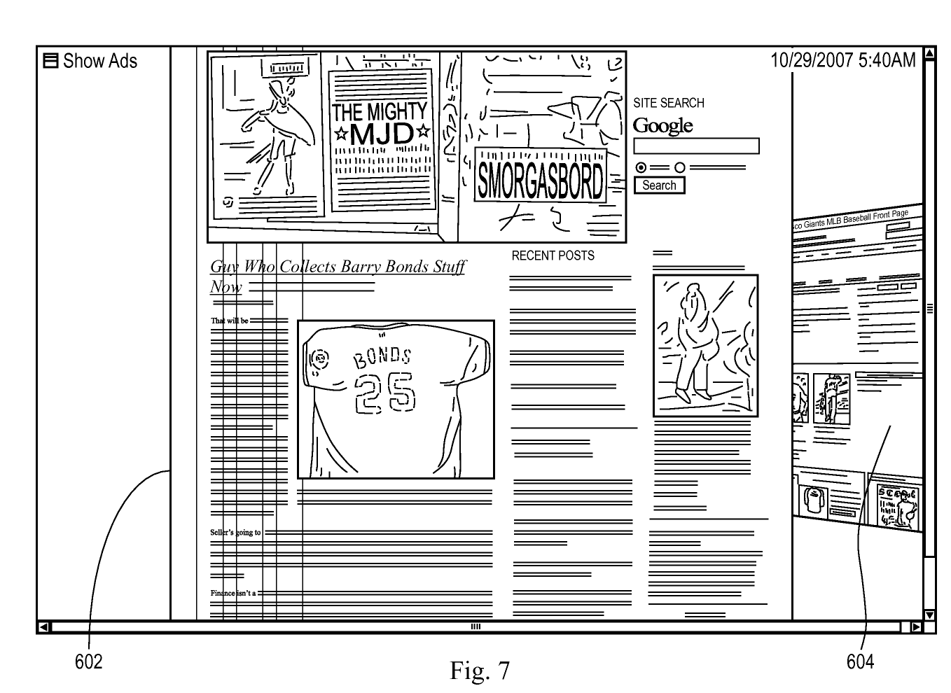

As illustrated from the transition of from FIG. 6 to FIG. 7, in some embodiments, responsive to a selection of the static representation of the source document of the search result occupying the center position 602 of the graphic output device 6 (FIG. 6), the size of the static graphic representation is enlarged (FIG. 7). For instance, in some embodiments, the static representation of the source document is enlarged by at least 10 percent, at least 20 percent, at least 30 percent, or at least 100 percent. Furthermore, referring to FIG. 7, responsive to a selection of a portion of the graphic output device 6 outside of the static representation of the source document occupying the center position 602 while it is in its enlarged state, the size of the static graphic representation of the source document is reduced back to the original size that it was before it was enlarged.

In some embodiments, responsive to a selection of the static representation occupying the center position 602, a web page impression from the source document of the first search result is retrieved. In other words, a “live” version of the document obtained from the URL or other address where the location was found while building the document index 150 is obtained and used to replace the static graphic representation of the source document.

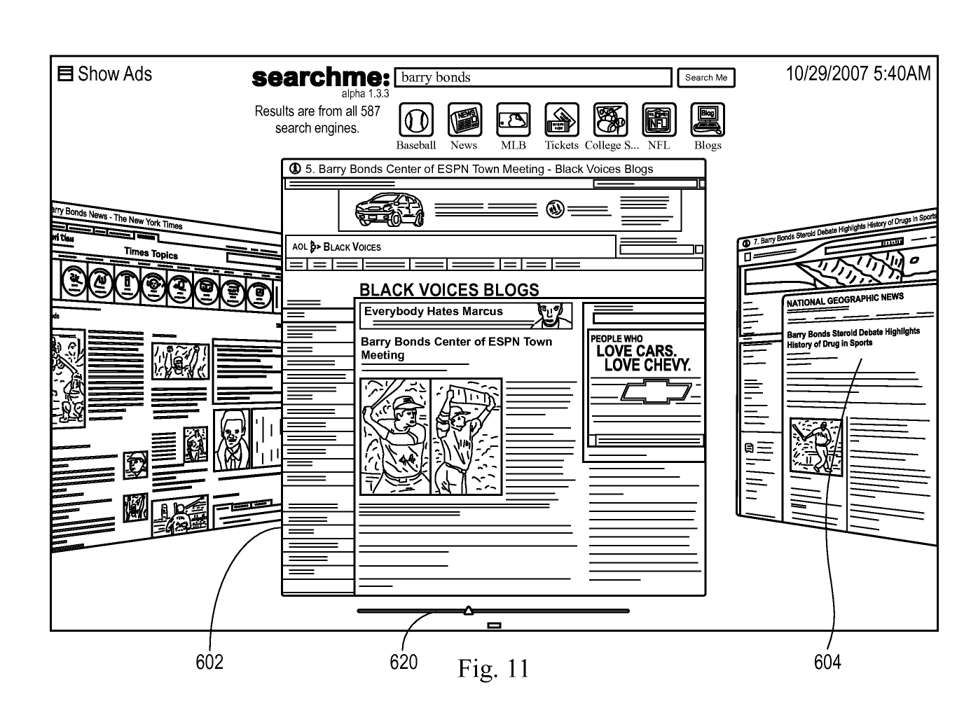

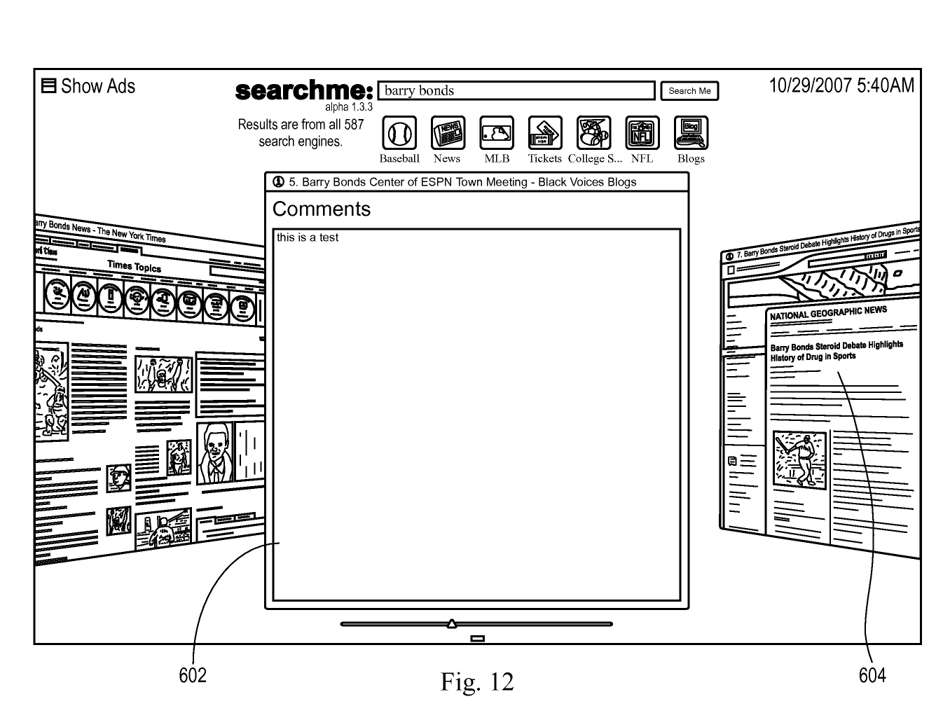

As illustrated by the transition from FIG. 11 to FIG. 12, responsive to a selection of the static representation of the source document of the search result occupying the center position 602 of the graphic output device, the static graphic representation of the source document is flipped from a first side (FIG. 11) to a reverse side (FIG. 12) so that the reverse side of the static graphic representation is shown. In some embodiments, the reverse side of the static graphic representation contains information associated with the static graphic representation. In some embodiments, the static graphic representation is flipped to the opposite side each time a first designated portion of the static graphic representation is selected (e.g., the top portion) and is enlarged when a second designated portion of the static graphic representation is selected (e.g., anything outside of the top portion).

In some instances, a toggle bar 620 is provided. See, for example, FIG. 6. When the search requester pulls the toggle bar 620 in a first direction (e.g., to the left), the displayed static graphic representations of the search results shift from the first off-center position 604 to the center position 602, and from the center position 602 to the second off-center position 608 responsive to the pull in the first direction. When the search requester pulls the toggle bar in a second direction (e.g., to the right), the static graphic representations of search results shift from the second off-center position 608 to the center position 602, and from the center position 602 to the first off-center position 604 responsive to the pull in the second direction.

In some embodiment, one of the graphic representations displays in the first off-center position 604, the center position 602, or the second off-center position 608 is an advertisement. In other words, rather than being a “hit” to a search query that was obtained from a vertical collection 144 or a document index 150, the graphic representation is an advertisement for services or products that may or may not be related to the search query. In some embodiments, the use of advertisements in this manner is accomplished by embedding the advertisement into the plurality of search results as a static graphic representation, so that, when the search requester pulls the toggle bar 620 in the first direction or the second direction, an advertisement is displayed in the center position 602.

In some embodiments, responsive to a selection and drag of the static graphic representation of the source document occupying the first off-center position 604, the center position, or the second off-center position 608, a copy of the static graphic representation of the source document of the first search result is stored in a predetermined or user specified location on the client device (e.g., a location in memory 20 and/or memory 114 of client device 100). This is advantageous for storing the image of hits to search queries.

In some embodiments, when the static graphic representation occupying the center position 602 is displayed for a predetermined amount of time without user input (e.g., for two seconds or more, for three seconds or more, for five seconds or more) the static graphic representation is automatically transformed, without user input, to a live impression from the source document.

In some embodiments, each of the documents in document index 150 and/or a vertical collection 144 that have been used by search engine 136 to perform a search based upon the search query provided by the user, are independently classified into one or more categories. For example the first document in the search results may be deemed to in categories one, three, five, and seven (e.g., sports, major league baseball, blogs, and news) and the second document in the search results may be deemed to be in categories five and seven (blogs and news). Such categorization provides advantages. For example, the search requester can request to remove a particular search result from the plurality of search results that were obtained in response to the user's original search query. For example, consider the above example in which the categories of the first document and the second document are described. Suppose that the search request removes the second document. In response to this request, the original search query is resubmitted with the specific request to not retrieve documents that are only in the blogs category or are only in the news category (or are only in both the blogs category and the news category). As a result, new search results relevant to the modified search query are obtained. Advantageously, the new search results are focused on the categories of documents in document index 150 or vertical collection 144 that the user did not exclude from the search.

In typical embodiments, the static graphic representation of the source document of each of the hits in the search results is a graphic representation of an entire web page taken from the location where the source document resides at a time before the submitted search query was received. For instance, the graphic representation of the entire web page may be taken when the source document is crawled during construction of the vertical collection.

In some embodiments, the method further comprises receiving, prior to obtaining the search results, a designation of a vertical collection in a plurality of vertical collections from the search requester. For instance, the user can select any of the icons for vertical collections 144 that are illustrated in FIGS. 3 through 6. In such embodiments, the search query and the designation of the vertical collection is submitted to vertical search engine server 180. Responsive to this request from the user, search engine 136 (or a specialized search engine used to search the designated vertical collection 144) searches the designated vertical collection 144 with the search query and returns a plurality of search results to the client 100.

In some embodiments, responsive to a search query from a search requester, client 100 submits the search query to vertical search engine server 180 without a designation of a vertical collection 144. In such instances, search engine 136 of vertical search engine server 180 searches document index 150 using the search query and provides the search results back to client 100. Client 100 then displays the plurality of search results from the vertical search engine server 180. In such embodiments, the document index that is searched, document index 150, is representative of the entire Internet (e.g., document index 150 is a random sampling of all the documents addressable by the Internet). This means that, typically, the documents in document index 150 are not restricted to a particular category of documents, such as sports, but rather can be of any category found in the Internet. In some embodiments, offensive documents are excluded from document index 150.

Another aspect of the invention provides a method for modifying a set of search results. First, a search request is received by a search requester. Then, a plurality of search results is obtained that are relevant to the submitted search query from a document index. If the architecture illustrated in FIG. 1 is used to perform such a search, the search request is received by web browser 34 and communicated to vertical search engine server 180 by network communication module 32 across Internet/network 126. Responsive to the search request, search engine 136 performs a search against a vertical collection 144 or document index 150 and then the search results are returned to client 100 by network communication module 132 using Internet/network 126 where the search results are displayed by web browser 34 as instructed by display module 36. Each search result in the plurality of search results comprises: (i) a source document or a reference to a source document and (ii) a static graphic representation of the source document, where the static graphic representation of the source document was obtained from the source document at a time before the submitted search query was received, and where each search result in said plurality of search results belongs to one or more categories. Then, the search requester removes a search result from the first plurality of search results. Responsive to the instructions to remove the search result, the search query is modified to account for the removal of the search result from the plurality of search results, thereby forming a modified search query. For instance, as in the example of two documents each belonging to multiple categories given above, the categories of documents to which the document that was removed by the user belongs are specifically excluded in the modified search query. A search of the document index 150 and or vertical collection 144 is then performed using the modified search query and the plurality of search results relevant to the modified search query are sent to client for 100 for display in accordance with the instructions provided in display module 36.

Still another aspect of the present application provides a computer program product for use in conjunction with a computer system, the computer program product comprising a computer readable storage medium and a computer program mechanism embedded therein, the computer program mechanism comprising instructions for performing and of the methods disclosed herein. For instance, in one embodiment, the computer program mechanism comprises instructions for receiving a submitted search query from a search requester and instructions for obtaining a plurality of search results relevant to the submitted search query from a document index, where each search result in said plurality of search results comprises (i) a source document or a reference to a source document and (ii) a static graphic representation of the source document, and where the static graphic representation of the source document was obtained from the source document at a time before the submitted search query was received. In this embodiment, the computer program mechanism further comprises instructions for displaying the static graphic representation of the source document of a first search result in the plurality of search results in a center position 602 of a graphic output device 6 as well as instructions for displaying the static graphic representation of the source document of a second search result in the plurality of search results in a first off-center position 604 of the graphic output device 6, where the static graphic representation of the source document of the second search result is displayed rotated about an axis of rotation 606 that lies between the center position 602 and the off-center position 604 of the graphic output device 6.

Another aspect of the present invention comprises a computer comprising a main memory, a processor and a program (e.g display module 36) stored in the main memory and executed by the processor that includes instructions for performing any of the methods disclosed herein. For example, in one embodiment, the program includes instructions for receiving a submitted search query from a search requester and instructions for obtaining a plurality of search results relevant to the submitted search query from a document index, where each search result in the plurality of search results comprises (i) a source document or a reference to a source document and (ii) a static graphic representation of the source document, where the static graphic representation of the source document was obtained from the source document at a time before the submitted search query was received. In this embodiment, the program further includes instructions for displaying the static graphic representation of the source document of a first search result in a center position 602 of a graphic output device 6 as well as instructions for displaying the static graphic representation of the source document of a second search result in an off-center position 604 of the graphic output device 6, where the static graphic representation of the source document of the second search result is displayed rotated about an axis of rotation 606 that lies between the center position 602 and the off-center position 604 of the graphic output device 6.

Still another aspect of the present application provides a system for providing search results responsive to a search query that comprises means for carrying out any of the methods disclosed in the instant application. One embodiment of such a system is illustrated in FIG. 1 and describe above. In one embodiment, such a system comprises means for receiving a submitted search query from a search requester as well as means for obtaining a plurality of search results relevant to the submitted search query from a document index, where each search result in the plurality of search results comprises (i) a source document or a reference to a source document and (ii) a static graphic representation of the source document, and where the static graphic representation of the source document was obtained from the source document at a time before the submitted search query was received. In such an embodiment, the system further comprises means for displaying the static graphic representation of the source document of a first search result in the plurality of search results in a center position of a graphic output device as well as means for displaying the static graphic representation of the source document of a second search result in the plurality of search results in an off-center position of the graphic output device, where the static graphic representation of the source document of the second search result is displayed rotated about an axis of rotation that lies between the center position and the off-center position of the graphic output device.

### Vertical Collections are Optional

The use of vertical collections 144 is entirely optional in the present disclosure. Thus, the present disclosure specifically encompasses embodiments that do not make use over vertical collections. In such embodiments, icons for vertical collections 144 are not displayed on client device 100. Further, in such embodiments, referring to FIG. 14, steps 1204, 1206-1218, and 1260 are not performed. Rather, control passes from step 1202 to step 1205. Upon the condition 1205-Yes, control passes to step 1280. Upon the condition 1205-No, control passes to back to step 1202. In some embodiments where vertical collections 144 are not used, control passes directly from step 1202 to step 1280 each time a search query is recited from a client computer 100.

### References Cited and Alternative Embodiments

All references cited herein are incorporated herein by reference in their entirety and for all purposes to the same extent as if each individual publication or patent or patent application was specifically and individually indicated to be incorporated by reference in its entirety for all purposes.

The present invention can be implemented as a computer program product that comprises a computer program mechanism embedded in a computer readable storage medium. For instance, the computer program product could contain the program modules shown in FIG. 1. These program modules can be stored on a CD-ROM, DVD, magnetic disk storage product, or any other computer readable data or program storage product. The software modules in the computer program product may also be distributed electronically, via the Internet or otherwise, by transmission of a computer data signal (in which the software modules are embedded) on a carrier wave.

Many modifications and variations of this invention can be made without departing from its spirit and scope, as will be apparent to those skilled in the art. The specific embodiments described herein are offered by way of example only. The embodiments were chosen and described in order to best explain the principles of the invention and its practical applications, to thereby enable others skilled in the art to best utilize the invention and various embodiments with various modifications as are suited to the particular use contemplated. The invention is to be limited only by the terms of the appended claims, along with the full scope of equivalents to which such claims are entitled.

What is claimed:

1. A method for providing search results responsive to a search query comprising:
receiving a submitted search query from a search requester;
obtaining a first plurality of search results relevant to the submitted search query from a document index, wherein at least a portion of the search results in said first plurality of search results comprises (i) a source document or a reference to a source document and (ii) a static graphic representation of the source document, wherein the static graphic representation of the source document was obtained from the source document at a time before the submitted search query was received;
displaying the static graphic representation of the source document of a first search result in said first plurality of search results in a center position of a graphic output device; and
displaying the static graphic representation of the source document of a second search result in said first plurality of search results in a first off-center position of the graphic output device; wherein the static graphic representation of the source document of the second search result is displayed rotated about a first axis of rotation that lies between the center position and the first off-center position of the graphic output device.

2. The method of claim 1, the method further comprising, responsive to a selection of the static graphic representation of the source document of the second search result in the first off-center position, the steps of:
shifting the static graphic representation of the source document of the first search result to a second off-center position of the graphic output device; thereby causing the static graphic representation of the source document of the first search result to be displayed at the second off-center position rotated about a second axis of rotation that lies between the center position and the second off-center position of the graphic output device;
shifting the static graphic representation of the source document of the second search result to the center position of the graphic output device; thereby causing the static graphic representation of the source document of the second search result to be displayed at the center position in a manner that is no longer rotated about the first axis of rotation; and
displaying the static graphic representation of the source document of a third search result in said first plurality of search results in the first off-center position of the graphic output device; wherein the static graphic representation of the source document of the third search result is displayed rotated about the first axis of rotation.

3. The method of claim 2, the method further comprising, responsive to a selection of the static graphic representation of the source document of the first search result in the second off-center position, the steps of:
shifting the static graphic representation of the source document of the first search result to the center position of the graphic output device; thereby causing the static graphic representation of the source document of the first search result to be displayed at the center position in a manner that is no longer rotated about the second axis of rotation; and
shifting the static graphic representation of the source document of the second search result to the first off-center position; thereby causing the static graphic representation of the source document of the second search result to be displayed at the first off-center position in a manner that is rotated about the first axis of rotation.

4. The method of claim 3, the method further comprising removing the static graphic representation of the source document of the third search result in the first off-center position.

5. The method of claim 1, the method further comprising, responsive to a selection of the static graphic representation of the source document of the first search result in said center position of the graphic output device, the step of enlarging a size of the static graphic representation of the source document of the first search result.

6. The method of claim 5, the method further comprising, responsive to a selection of a portion of the graphic output device outside of the static graphic representation of the source document of the first search result when the static graphic representation of the source document of the first search result is in an enlarged state, the step of reducing the size of the static graphic representation of the source document of the first search result to an original size.

7. The method of claim 1, the method further comprising, responsive to a selection of the static graphic representation of the source document of the first search result, the steps of:
retrieving a web page impression from the source document of the first search result; and
replacing the static graphic representation of the source document with the web page impression.

8. The method of claim 1, the method further comprising, responsive to a selection of the static graphic representation of the source document of the first search result in said center position of the graphic output device, the step of flipping the static graphic representation of the source document of the first search result from a first side to a reverse side so that the reverse side of the static graphic representation is shown.

9. The method of claim 8, wherein the reverse side of the static graphic representation contains information associated with the static graphic representation.

10. The method of claim 1, the method further comprising:
providing a toggle bar on the graphic output device, wherein,
when the search requester pulls the toggle bar in a first direction, static graphic representations of search results in the first plurality of search results shift from the first off-center position to the center position, and from the center position to a second off-center position responsive to the pull in the first direction; and
when the search requester pulls the toggle bar in a second direction, static graphic representations of search results in the first plurality of search results shift from the second off-center position to the center position, and from the center position to the first off-center position responsive to the pull in the second direction.

11. The method of claim 10, the method further comprising embedding an advertisement into the first plurality of search results as a static graphic representation, wherein, when the search requester pulls the toggle bar in the first direction or the second direction, an advertisement is displayed in the center position.

12. The method of claim 1, the method further comprising:
responsive to a selection and drag on the static graphic representation of the source document of the first search result in the direction of a predetermined position on the graphic output device, storing a copy of the static graphic representation of the source document of the first search result on a client device.

13. The method of claim 1, the method further comprising embedding an advertisement into the first plurality of search results as a static graphic representation.

14. The method of claim 1, the method further comprising automatically transforming, without user input, the static graphic representation of the source document of the first search result to a live impression from the source document.

15. The method of claim 1, wherein each search result in said first plurality of search results belongs to one or more categories; the method further comprising:
receiving instructions from the search requester to remove a search result from said first plurality of search results and, responsive to the instructions to remove the search result,
(i) modifying the search query to account for the removal of the search result from the first plurality of search results, thereby forming a modified search query;
(ii) submitting the modified search query to a search engine in a remote computer; and
(iii) obtaining a second plurality of search results relevant to the modified search query.

16. The method of claim 1, wherein the static graphic representation of the source document is a graphic representation of an entire web page at said time before the submitted search query was received.

17. The method of claim 1, the method further comprising:
receiving, prior to the obtaining step, a designation of a vertical collection in a plurality of vertical collections from the search requester; and wherein
the receiving step further comprises submitting the search query and the designation of a vertical collection to a vertical search engine server; and
the displaying step further comprises receiving the plurality of search results from the vertical search engine server and wherein the document index is said vertical collection.

18. The method of claim 1, wherein
the receiving step further comprises submitting the search query to a vertical search engine server; and
the displaying step further comprises receiving the plurality of search results from the vertical search engine server and wherein the document index is representative of the entire Internet.

19. A method for modifying a set of search results, comprising:
receiving a search request from a search requester;
obtaining a first plurality of search results relevant to the submitted search query from a document index, wherein each search result in said first plurality of search results comprises: (i) a source document or a reference to a source document and (ii) a static graphic representation of the source document, wherein the static graphic representation of the source document was obtained from the source document at a time before the submitted search query was received, and wherein each search result in said first plurality of search results belongs to one or more categories;
receiving instructions from the search requester to remove a search result from said first plurality of search results and, responsive to the instructions to remove the search result,
(i) modifying the search query to account for the removal of the search result from the first plurality of search results, thereby forming a modified search query;
(ii) performing a search of the document index using the modified search query; and
(iii) outputting a second plurality of search results relevant to the modified search query.

20. A computer program product for use in conjunction with a computer system, the computer program product comprising a computer readable storage medium and a computer program mechanism embedded therein, the computer program mechanism comprising:
instructions for receiving a submitted search query from a search requester;
instructions for obtaining a plurality of search results relevant to the submitted search query from a document index, wherein each search result in said plurality of search results comprises (i) a source document or a reference to a source document and (ii) a static graphic representation of the source document, wherein the static graphic representation of the source document was obtained from the source document at a time before the submitted search query was received;
instructions for displaying the static graphic representation of the source document of a first search result in said plurality of search results in a center position of a graphic output device; and
instructions for displaying the static graphic representation of the source document of a second search result in said plurality of search results in an off-center position of the graphic output device; wherein the static graphic representation of the source document of the second search result is displayed rotated about an axis of rotation that lies between the center position and the off-center position of the graphic output device.

21. A computer, comprising:
a main memory;
a processor;
and a program, stored in the main memory and executed by the processor, the program including instructions for:
receiving a submitted search query from a search requester;
obtaining a plurality of search results relevant to the submitted search query from a document index, wherein each search result in said plurality of search results comprises (i) a source document or a reference to a source document and (ii) a static graphic representation of the source document, wherein the static graphic representation of the source document was obtained from the source document at a time before the submitted search query was received;
displaying the static graphic representation of the source document of a first search result in said plurality of search results in a center position of a graphic output device; and
displaying the static graphic representation of the source document of a second search result in said plurality of search results in an off-center position of the graphic output device; wherein the static graphic representation of the source document of the second search result is displayed rotated about an axis of rotation that lies between the center position and the off-center position of the graphic output device.

22. A system for providing search results responsive to a search query, comprising:
means for receiving a submitted search query from a search requester;
means for obtaining a plurality of search results relevant to the submitted search query from a document index, wherein each search result in said plurality of search results comprises (i) a source document or a reference to a source document and (ii) a static graphic representation of the source document, wherein the static graphic representation of the source document was obtained from the source document at a time before the submitted search query was received;
means for displaying the static graphic representation of the source document of a first search result in said plurality of search results in a center position of a graphic output device; and
means for displaying the static graphic representation of the source document of a second search result in said plurality of search results in an off-center position of the graphic output device; wherein the static graphic representation of the source document of the second search result is displayed rotated about an axis of rotation that lies between the center position and the off-center position of the graphic output device.
